(19) United States
(12) Patent Application Publication
(10) Pub. No.: US 2005/0272408 A1
(43) Pub. Date: Dec. 8, 2005

(54) Method for personal notification indication

(76) Inventors: Deanna Wilkes-Gibbs, Palo Alto, CA (US); John Buford, Lawrenceville, NJ (US)

Correspondence Address: HARNESS, DICKEY & PIERCE, P.L.C., P.O. BOX 828, BLOOMFIELD HILLS, MI, 48303, US

(21) Appl. No.: 10/862,163

(22) Filed: Jun. 4, 2004

(51) Int. Cl. H04M 1/00

(52) U.S. Cl. 455/412.2; 455/412.1

(57) ABSTRACT

Personal jewelry or other wearable electronic devices provide a visual, audio, vibration and/or tactile indication to the user when an incoming call, instant message, presence attribute change, calendar event or proximity reminder occurs. A personal area network mediates the incoming information and communicates it with one or more wearable devices associated with the user. The personal area network may communicate directly with other communication devices operated by the user, and also with networked devices via a gateway.

### BACKGROUND OF THE INVENTION

The present invention relates generally to wearable personal communication systems. More particularly, the invention relates to a personal notification system that works in conjunction with a personal area network to handle a variety of communications tasks on behalf of the user.

The cellular telephone has become perhaps the most widely used personal communication device. Cellular phones are popular because they are relatively small and portable, and because they can support both voice communication and text messaging or instant messaging. While unquestionably popular, cellular phones are not always convenient. They must be switched on (i.e., placed in a receive mode) otherwise incoming calls may be missed. Moreover, even when switched on, users sometimes find it inappropriate to employ an audible ring tone and may thus miss calls (e.g., the user may turn the audible ring tone off when in a church service or quiet theater). Although cellular telephones do have a silent “vibration” mode that provides an indication of an incoming call, the vibration mode is not always entirely effective. When the phone is set to vibration mode and the user places the phone in a briefcase, handbag or purse, the incoming call may not be detected because the vibration signal may not be felt.

### SUMMARY OF THE INVENTION

The present invention provides a personal notification system and method that employs personal jewelry or other wearable electronic devices to provide a visual, audible, vibration and/or tactile indication or message to the user when an incoming phone call, instant message, presence attribute change, calendar event or proximity reminder occurs. The device is preferably connected with other devices, such as the user's cell phone, through a personal area network or wireless device network. The indication or message provided to the user can be triggered by the incoming event occurring on a preferred communication system (such as a cellular telephone system) even though the user's device (e.g., cellular telephone) happens to be shut off or not immediately accessible at the time. The system allows events to be pre-selected for indication according to priority, type, sender, subject, or other attributes. The user may control the timing and delivery of the indication using preferences that are set either locally on the device or remotely.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention. Accordingly, for a more complete understanding of the invention, its objects and advantages, refer to the remaining specification and to the accompanying drawings.

### BRIEF DESCRIPTION OF THE DRAWINGS

The present invention will become more fully understood from the detailed description and the accompanying drawings, wherein:

FIG. 1 is a block diagram of the personal notification indication system of the invention;

FIG. 2 is a use case diagram illustrating a first scenario where primary communication devices are inaccessible and where notification is sent to a personal area network device;

FIG. 3 is a use case diagram illustrating a scenario where one or more wearable devices are network enabled through a personal area network;

FIG. 4 is a use case diagram illustrating a scenario where device presence and presence notification techniques are used as the signaling mechanism;

FIG. 5 is a use case diagram illustrating a scenario employing message forwarding as the signaling mechanism;

FIG. 6 is a use case diagram illustrating a scenario employing a gateway to effect signaling;

FIG. 7 is a use case diagram illustrating a scenario where notifications are filtered and/or prioritized.

### DETAILED DESCRIPTION OF THE PREFERRED EMBODIMENTS

The following description of the preferred embodiment(s) is merely exemplary in nature and is in no way intended to limit the invention, its application, or uses.

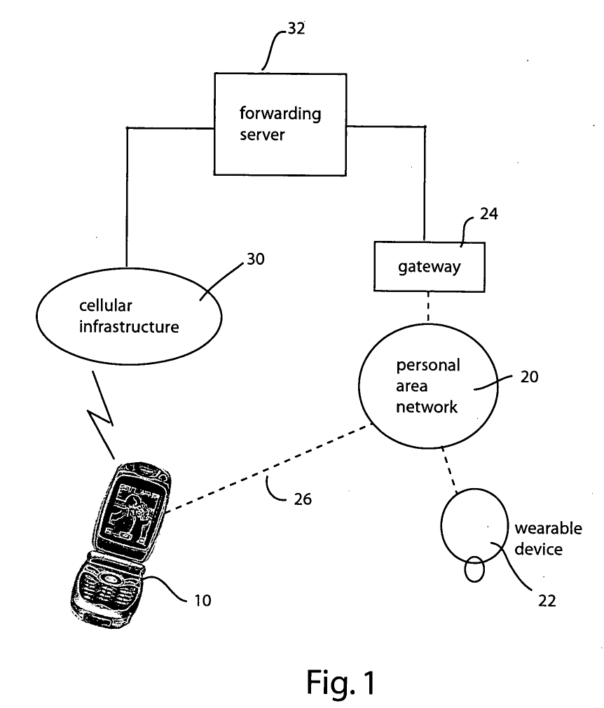

Referring to FIG. 1, the system for personal notification indication will now be described. The system is shown in FIG. 1 in conjunction with a cellular telephone 10. It will be understood that the illustration of a cellular telephone in FIG. 1 is simply intended to demonstrate the principles of the invention. Other types of devices may be used in the alternative. Some examples include personal digital assistant devices (PDAs), pagers, laptop computers, music players (e.g., mp3 players) and the like.

The personal notification indication system preferably employs a personal area network 20 that defines a local area network that is uniquely associated with the user. In one embodiment the personal area network is a wireless network supported by a miniaturized portable base station that the user either places in his or her proximity or carries with him, either by wearing or by placing in carried wallet, purse, briefcase or luggage. The personal area network is adapted to communicate with at least one wearable device, such as device 22 in FIG. 1. Wearable devices may range from a wearable display, bracelet, hairpiece, watch, ring, eyeglasses, clothing or tattoo. If desired, the personal area network base station may be embedded in the personal device itself. Thus the user can carry his or her personal area network with him simply by wearing or carrying the wearable device.

Associated with the personal area network 20 is an optional gateway device 24 that provides network connectivity to another networked computer system, such as the internet. If desired, gateway 24 may be embedded in the personal area network base station, which, in turn, may be embedded in the wearable device.

The personal area network preferably operates using at least one wireless protocol. Examples of such wireless protocol include 802.11 and Bluetooth. In FIG. 1 the wireless communication signals are illustrated by dotted lines.

The personal area network is capable of communication with a variety of different types of devices that have suitable wireless communication capabilities. For purposes of illustration, a cellular telephone 10 is illustrated having the ability to communication wirelessly with the personal area network as illustrated by the dotted communication line 26. In addition, the cellular telephone also communicates in the conventional manner to the cellular infrastructure 30. The cellular infrastructure 30 represents the normal means by which a user would place and receive telephone calls using cellular phone 10.

In some applications, the system can also be configured to include a forwarding server 32. The forwarding server may be a server communicating over the internet and thus having connectivity to the gateway 24. In addition, by establishing a networked connection between the forwarding server 32 and the cellular infrastructure 30, it is possible for the forwarding server to handle message routing issues as will be more fully explained below.

When a third party wishes to call the user on his or her cell phone 10, the third party simply places a call to the cell phone and must rely upon the user to answer. However, in some situations, where the device is either switched off or the ringer has been disabled or is not heard, the user may not answer. In situations where the device is still supplied with power, but simply not alerting the user to the incoming call, the device 10 may contact the personal area network directly via the wireless communication channel illustrated at 26. This will cause the wearable device to provide the user with a notification indication. In instances where the device 10 is powered off or lacking sufficient battery charge to operate, the unanswered call is recognized by the forwarding server system 32 and the forwarding server system then communicated through gateway 24 to the personal area network, sending the personal notification indication or message to the user via the wearable device 22. The notification indication or message can be a simple substitute for the telephone ring tone (sensed by any appropriate means including tactile, audible and/or visible). The notification indication or message can be more complex, as well, ranging from an instant message presented to the user via the wearable device 22 to a full re-routing of the incoming call, allowing the user to communicate with the calling party using the wearable device as a proxy for the cell phone 10.

The forwarding server may be configured to perform this function automatically, based on preprogrammed instructions or preferences of the user, or it may be configured to do so at the election of the third party caller. In the latter case, when the third party caller either detects a busy signal or no answer by the device 10, the third party caller can send a message through the forwarding server 32, causing the forwarding server to alert the user via his or her wearable device 22.

The personal area network 20 is preferably configured to operate in compliance with instant messaging protocols, including availability and presence protocols. Thus a user may use an interface on the wearable device 22, or on some other device communicating with the personal area network 20, to set his or her status to “unavailable” or some other designation. The presence and availability attributes may then be communication through gateway 24 to a suitable instant messaging server system. Doing this will allow third party callers to access the presence and availability information, to determine whether the user may be reached via the wearable device or via other devices that are mediated by the personal area network. This gives the user a great deal of flexibility on how he or she wishes to receive communications from third parties. The personal area network can be configured to include a set of rules, whereby certain messages are permitted to “ring through” to the wearable device, while other messages may be filtered out. Thus by setting a device to the status of “busy” or “away”, the user can render a wearable device inaccessible to either all third parties or selected third parties.

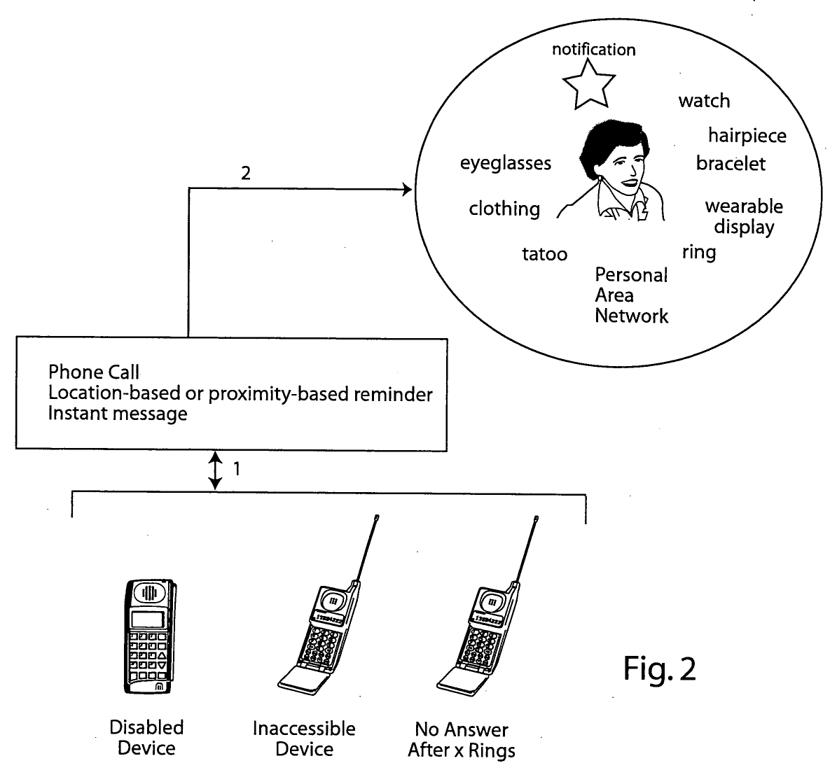

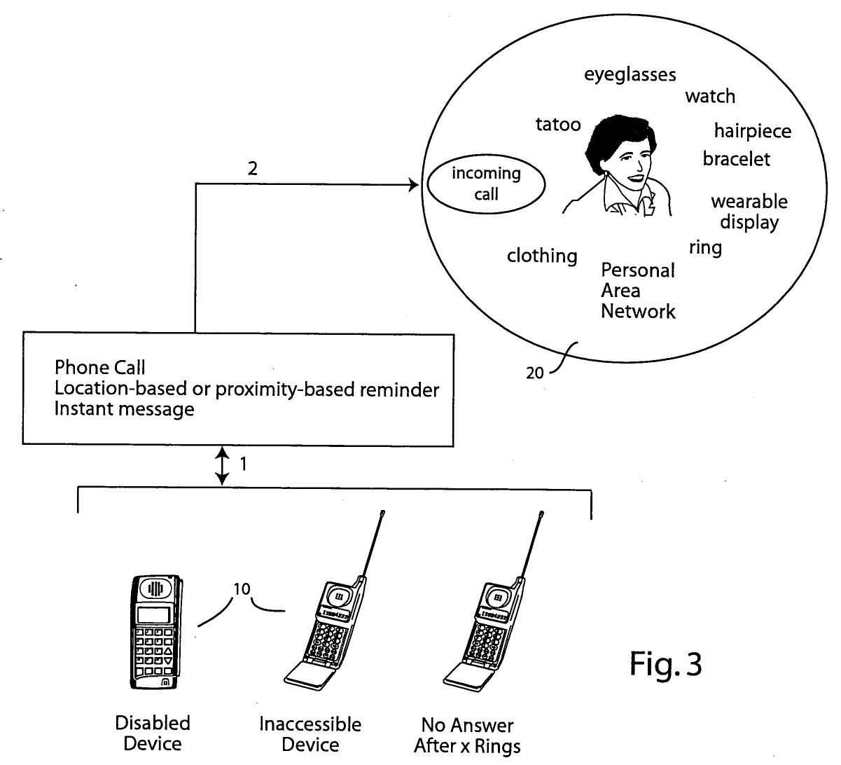

For a better understanding of the capabilities of the invention, a series of use cases will now be described. Referring first to FIG. 2, a simple use of the invention is illustrated. FIGS. 2 and 3 illustrate variations of a technique whereby messages sent from a third party to the user's portable device (e.g., cell phone) are deemed inaccessible and hence the wearable device is utilized instead. In FIG. 2, the incoming call from a third party may be a telephone call, location-based or proximity-based reminder message, or an instant message. The incoming message cannot be received or displayed by the device 10 either because the device is disabled, rendered inaccessible, or because the user does not answer it after a predetermined number of rings. The device 10, itself, or the forwarding server 32 (FIG. 1) detects that device 10 is not being used and it automatically forwards a notification to the user's wearable device. In the scenario of FIG. 2, the notification may be a simple ring notification, alerting the user that he or she needs to answer the cell phone.

The use case scenario of FIG. 3 extends the functionality of the scenario of FIG. 2. In this scenario the incoming call, reminder or message is forwarded to the personal area network 20 so that the user can handle the incoming call, reminder or message using the wearable device itself. Thus, the user might read an instant message on a wearable display, or the user might participate in a communication with the third party using a device such as a wristwatch. The communication with the third party would be thus communication wirelessly from the wearable device 22 (FIG. 1) through the personal area network 20 to the user's cell phone 10 (FIG. 1). The cell phone 10 would then communicate in the conventional fashion over the cellular infrastructure 30. This would allow the user, for example, to handle a brief telephone call by speaking into his or her wristwatch, with the wristwatch, in turn, relaying the conversation through the user's cell phone, which might remain in the user's purse or briefcase. Alternatively, the message may be routed through gateway 24 whereby using voice over IP (VoIP) services to communicate the call through the forwarding service 32 instead of through the cellular infrastructure 30.

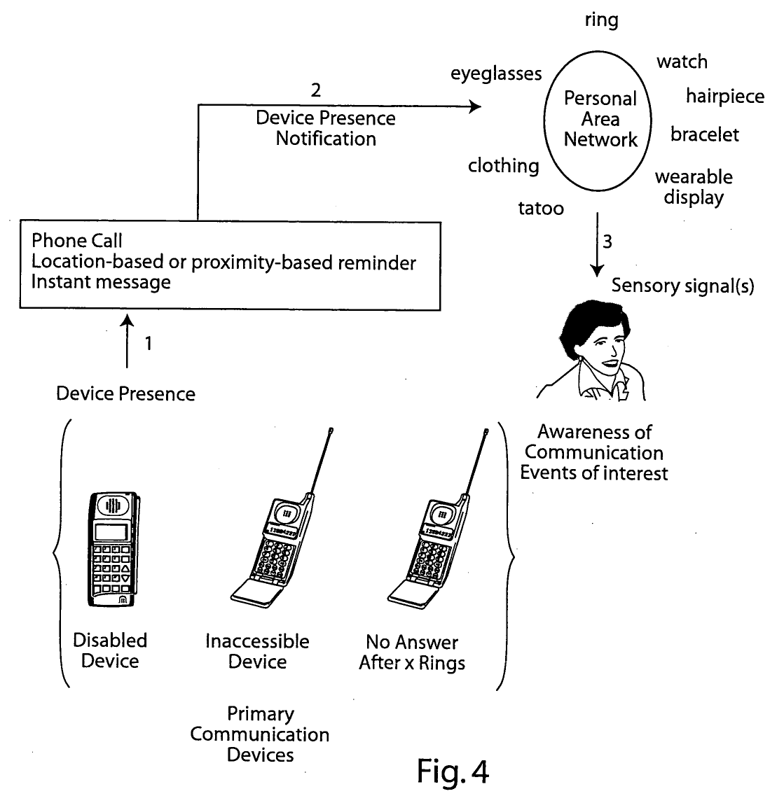

FIG. 4 illustrates another scenario, where a presence service is used in the personal area notification sequence. The presence service allows the user and the user's device state to be published to other presence subscribers, including communication services. The user or device presence can then be set to indicate unavailability. A notification of an attempt to communicate with the user can then be forwarded to the wearable device or devices.

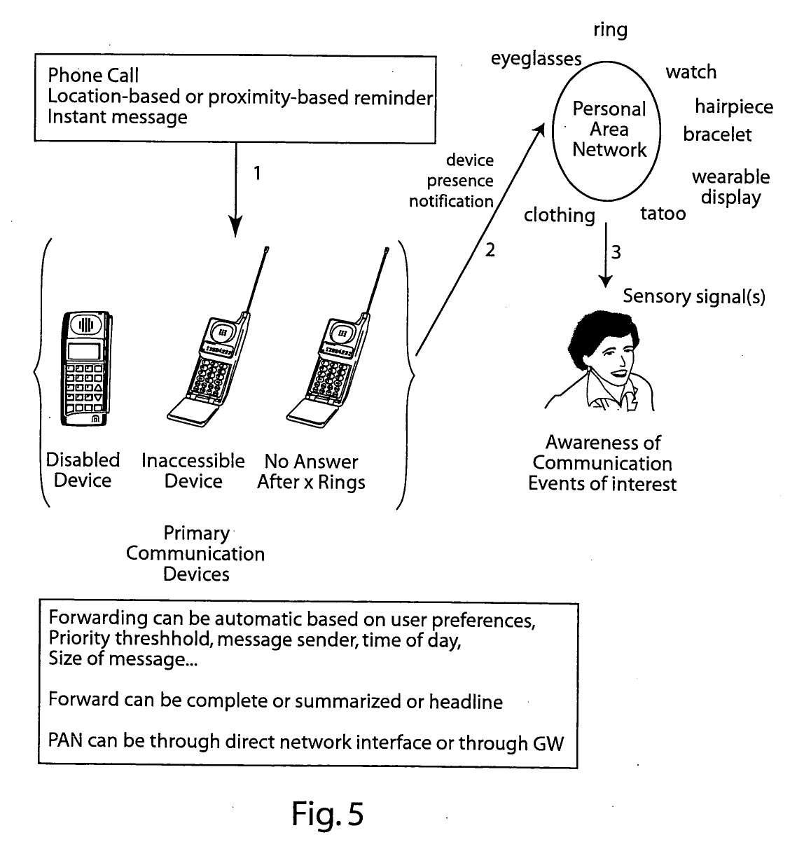

FIG. 5 shows a mechanism by which the indication signal comes, not through the service provided, but directly from the mobile communication device 10. This requires that there is a network path to the wearable device from the mobile communication device. Other than this, the communication mechanisms are similar. Filtering and prioritizing of indications can be performed.

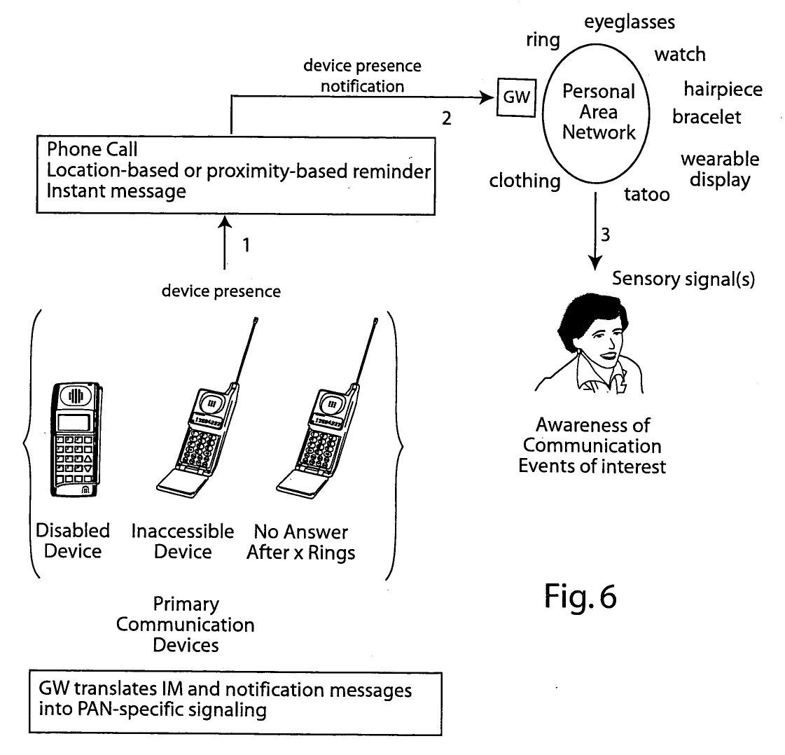

FIG. 6 illustrates how signaling through a gateway may be performed. The third party places a call to the user, and the device is rendered inaccessible. The gateway translates instant messages and notification messages into personal area network-specific signaling. In this way, the user is able to interact with instant messages and notification messages sent from outside third parties.

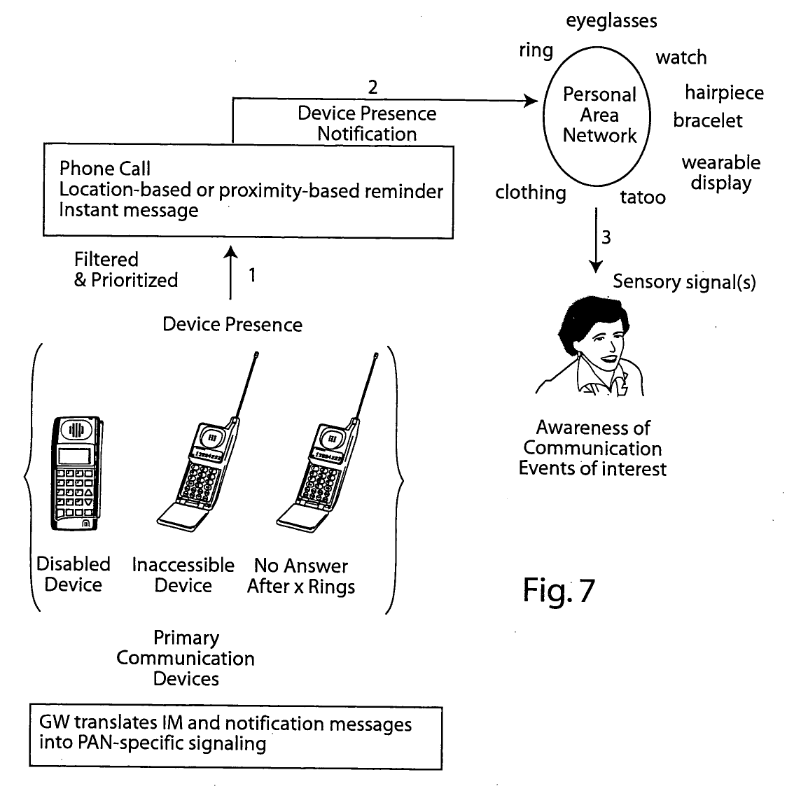

FIG. 7 illustrates how notifications may be filtered or prioritized. Preferably, incoming messages are filtered either in the gateway 24 (FIG. 1) or by some other device on personal area network 20.

The description of the invention is merely exemplary in nature and, thus, variations that do not depart from the gist of the invention are intended to be within the scope of the invention. Such variations are not to be regarded as a departure from the spirit and scope of the invention.

1. A method for personal notification comprising:
establishing a personal area network associated with a receiving party;
initiating a call to said receiving party by initiating communication with receiving party communication device;
detecting an unavailability condition associated with said communication device;
upon detecting said unavailability condition, sending an instant message through said personal area network to an instant message appliance coupled to said network and in the physical proximity of the receiving party.

2. The method of claim 1 wherein said communication device is a cellular telephone.

3. The method of claim 1 wherein said instant message appliance is a wearable device worn by the receiving party.

4. The method of claim 1 wherein said step of establishing a personal area network is performed by placing a wireless network in signal-receiving proximity to said receiving party.

5. The method of claim 4 wherein said wireless network is placed by incorporating a wireless base station into a wearable device worn by the receiving party.

6. The method of claim 1 wherein said unavailability condition corresponds to a disabled device condition of said communication device.

7. The method of claim 1 wherein said unavailability condition corresponds to an inaccessible device condition of said communication device.

8. The method of claim 1 wherein said unavailability condition corresponds to a condition whereby said receiving party does not answer said communication device.

9. The method of claim 1 further comprising using said communication device to communicate with said personal area network to send said instant message.

10. The method of claim 1 further comprising using a forwarding server to communicate with said personal area network to send said instant message.

11. The method of claim 1 further comprising setting a presence attribute and communicating said attribute over said personal area network.

12. The method of claim 1 further comprising using said personal area network to send said instant message to a selected one of a plurality of devices associated with the receiving party.

13. A system for delivering personal notification information, comprising:
a personal area network associated with a receiving party;
an instant message appliance communicating with said network and in the physical proximity of the receiving party;
a system that detects an unavailability condition in a communication device associated with said receiving party and that provides a notification to the receiving party via said instant message appliance when said unavailability condition is detected.

14. The system of claim 13 wherein said personal area network includes a base station adapted to be worn by the receiving party.

15. The system of claim 13 wherein said instant message appliance is adapted to be worn by the receiving party.

16. The system of claim 13 wherein said personal area network includes a gateway adapted to establish communication over the internet.

17. The system of claim 13 wherein said personal area network includes a base station embedded in said instant message appliance.

18. The system of claim 13 wherein said communication device communicates with said personal area network.

19. The system of claim 13 further comprising a forwarding server adapted to receive messages from a communication device of a calling party and to forward said received messages to said personal area network.

20. The system of claim 13 wherein said communication device is a cellular telephone.
